(19) United States
(12) Patent Application Publication
(10) Pub. No.: US 2024/0218699 A1
(43) Pub. Date: Jul. 4, 2024

(54) Electric Lock and Control Method Thereof

(71) Applicant: Taiwan Fu Hsing Industrial Co., Ltd., Kaohsiung City (TW)

(72) Inventors: I-Chang Shih, Kaohsiung City (TW); Shih-Min Lu, Kaohsiung City (TW); Pi-Shun Chang, Kaohsiung City (TW)

(21) Appl. No.: 18/149,257

(22) Filed: Jan. 3, 2023

(30) Foreign Application Priority Data
Feb. 15, 2022 (TW) 111105493

(51) Int. Cl. E05B 47/00

(52) U.S. Cl. CPC E05B 47/00; E05B 2047/0068; E05B 2047/0069

(57) ABSTRACT

An electric lock includes a latch bolt movable relative to a door between a locking position and an unlocking position; an actuator configured to drive the latch bolt to move; a first sensing device configured to sense a position of the latch bolt; a second sensing device configured to sense whether the door is located at a closing position; and a processing unit configured to control the actuator to drive the latch bolt to move. In a state of the first sensing device sensing that the latch bolt is located at the unlocking position and the second sensing device sensing that the door is not located at the closing position, the processing unit is configured to control the actuator to drive the latch bolt to move to the locking position when the second sensing device further senses that the door is moved to the closing position.

### BACKGROUND OF THE INVENTION

### 1. Field of the Invention

The present invention relates to an electric lock, and more particularly, to an electric lock capable of improving security of a delayed locking mechanism.

### 2. Description of the Prior Art

Generally, an electric lock has a delayed locking mechanism to allow a user to enter or exit through a door conveniently. For example, when the user unlocks the electric lock, the electric lock is configured to drive the latch bolt to move to an unlocking position for allowing the user to open the door, and when the latch bolt has been moved to the unlocking position for a delay time, the electric lock is configured to drive the latch bolt to move to a locking position, so that the electric lock will return to a locked state. However, during a process of the electric lock executing the delayed locking mechanism, the latch bolt is held at the unlocking position before an end of the delay time even the door has been closed. In other words, the door can be re-opened before the end of the delay time. Therefore, the delayed locking mechanism of the electric lock of the prior art has poorer security.

### SUMMARY OF THE INVENTION

The present invention provides an electric lock and a control method thereof in order to solve the problems of the prior art.

An electric lock of the present invention comprises a latch bolt movable relative to a door between a locking position and an unlocking position; an actuator configured to drive the latch bolt to move; a first sensing device configured to sense a position of the latch bolt; a second sensing device configured to sense whether the door is located at a closing position; and a processing unit configured to control the actuator to drive the latch bolt to move; wherein in a state of the first sensing device sensing that the latch bolt is located at the unlocking position and the second sensing device sensing that the door is not located at the closing position, the processing unit is configured to control the actuator to drive the latch bolt to move to the locking position when the second sensing device further senses that the door is moved to the closing position.

An electric lock control method of the present invention comprises arranging an electric lock on a door, wherein the electric lock comprises a latch bolt, an actuator, a first sensing device, a second sensing device and a processing unit, wherein the latch bolt is movable relative to the door between a locking position and an unlocking position; the first sensing device sensing a position of the latch bolt; the second sensing device sensing whether the door is located at a closing position; and in a state of the first sensing device sensing that the latch bolt is located at the unlocking position and the second sensing device sensing that the door is not located at the closing position, the processing unit controlling the actuator to drive the latch bolt to move to the locking position when the second sensing device further senses that the door is moved to the closing position.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an electric lock of the present invention;

FIG. 2 is a diagram showing a latch bolt of the electric lock of the present invention being located at a locking position and a door being located at a closing position;

FIG. 3 is a diagram showing the latch bolt of the electric lock of the present invention being located at an unlocking position and the door being located at the closing position;

FIG. 4 is a diagram showing the latch bolt of the electric lock of the present invention being located at the unlocking position and the door being away from the closing position; and

FIG. 5 is a flow chart of a control method of the electric lock of the present invention.

### DETAILED DESCRIPTION

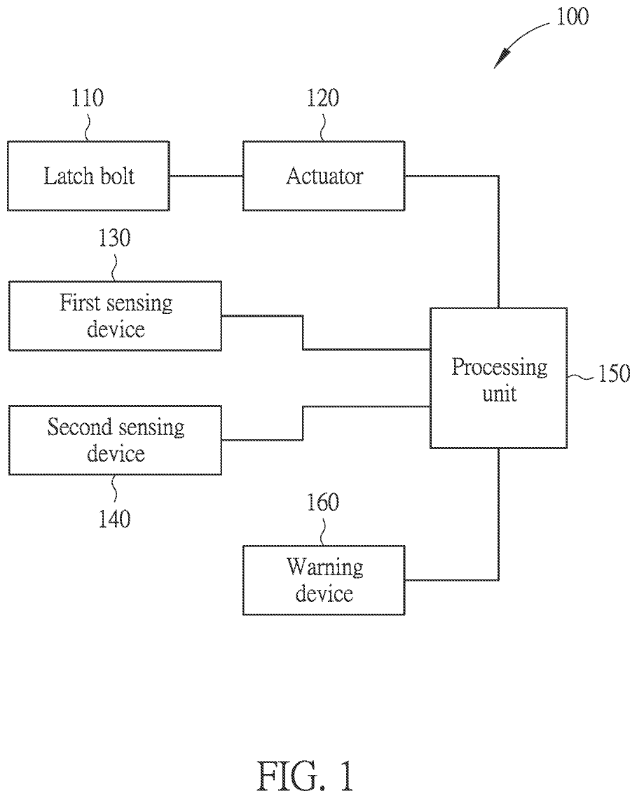

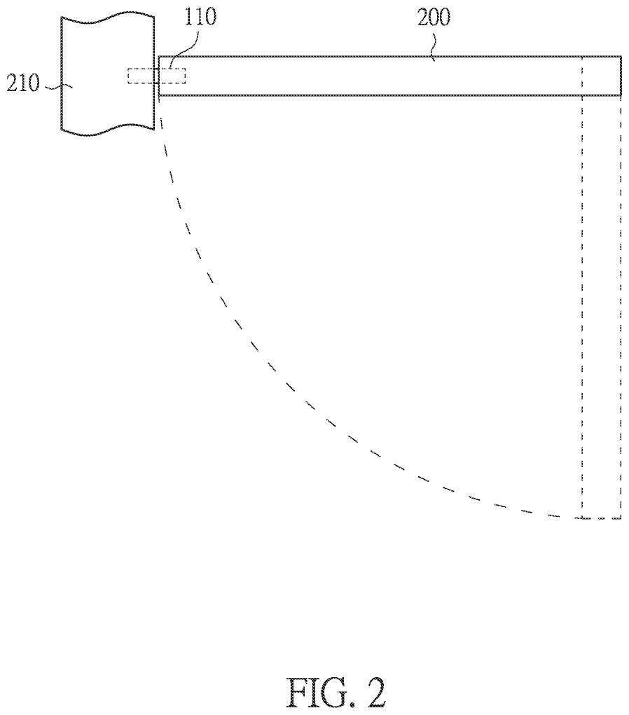

Please refer to FIG. 1. FIG. 1 is a functional block diagram of an electric lock of the present invention. As shown in the figure, the electric lock 100 of the present invention comprises a latch bolt 110, an actuator 120, a first sensing device 130, a second sensing device 140 and a processing unit 150. The latch bolt 110 is movable relative to a door (such as a door 200 in FIG. 2 to FIG. 4) between a locking position and an unlocking position. The actuator 120 is configured to drive the latch bolt 110 to move between the locking position and the unlocking position. The first sensing device 130 is configured to sense a position of the latch bolt 110. For example, the first sensing device 130 can comprise two micro switches corresponding to the locking position and the unlocking position of the latch bolt 110 respectively. When the latch bolt 110 is moved to the locking position, the micro switch corresponding to the locking position is configured to generate a locking position signal; and when the latch bolt 110 is moved to the unlocking position, the micro switch corresponding to the unlocking position is configured to generate an unlocking position signal, but the present invention is not limited thereto. The first sensing device 130 can comprise other types of sensors, such as a photo-interrupter, a position sensor, a magnetic sensor, and the like for sensing the position of the latch bolt 110. The second sensing device 140 is configured to sense whether the door is located at a closing position. For example, the second sensing device 140 can comprise at least one micro switch corresponding to the closing position of the door. When the door is located at the closing position, the micro switch corresponding to the closing position is configured to generate a closing position signal; and when the door is moved away from the closing position, the micro switch corresponding to the closing position no longer generates the closing position signal, but the present invention is not limited thereto. The second sensing device 140 can comprise other types of sensors, such as a photo-interrupter, a position sensor, a magnetic sensor, and the like for sensing whether the door is located at the closing position. The processing unit 150 is configured to control the actuator 120 to drive the latch bolt 110 to move. For example, when the processing unit 150 sends a locking control signal to the actuator 120, the actuator 120 is configured to drive the latch bolt 110 to move to the locking position. When the processing unit 150 sends an unlocking control signal to the actuator 120, the actuator 120 is configured to drive the latch bolt 110 to move to the unlocking position.

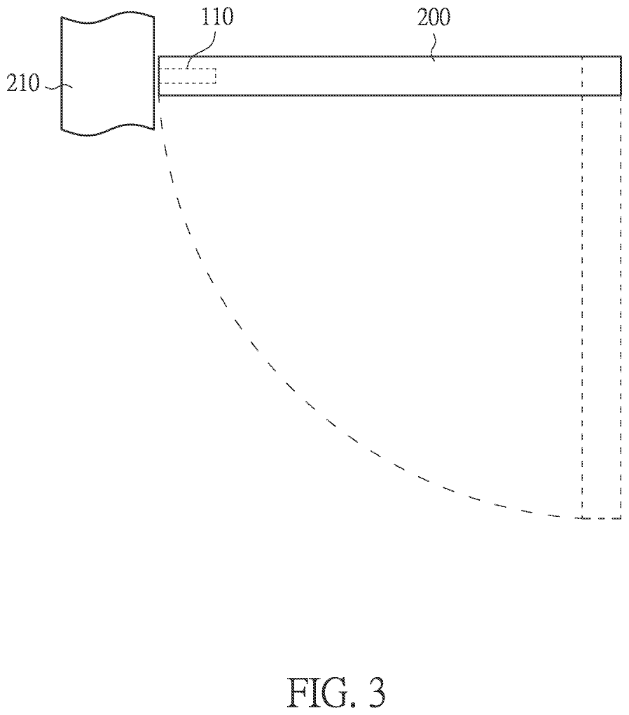

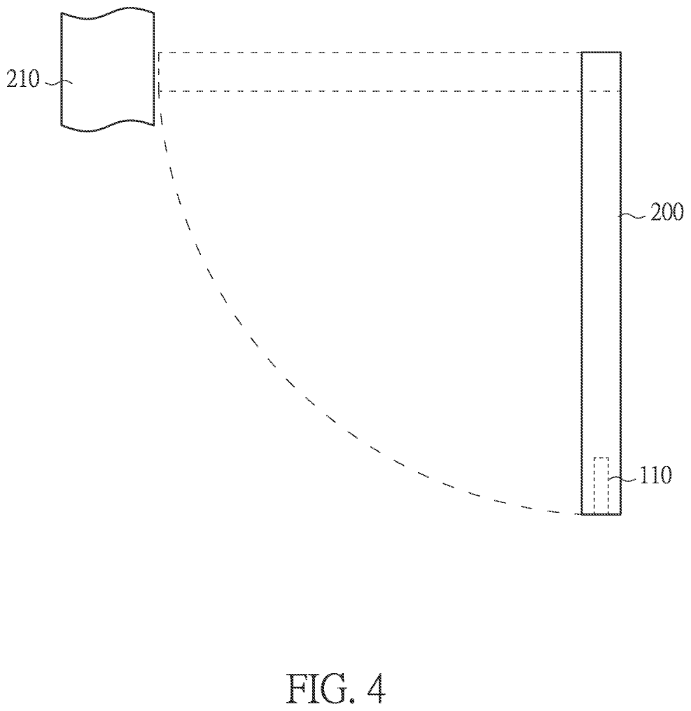

Please refer to FIG. 2 to FIG. 4, and refer to FIG. 1 as well. FIG. 2 is a diagram showing the latch bolt of the electric lock of the present invention being located at the locking position and the door being located at the closing position. FIG. 3 is a diagram showing the latch bolt of the electric lock of the present invention being located at the unlocking position and the door being located at the closing position. FIG. 4 is a diagram showing the latch bolt of the electric lock of the present invention being located at the unlocking position and the door being away from the closing position. When the electric lock 100 is in a locked state, the latch bolt 110 of the electric lock 100 is located at the locking position and the door 200 is located at the closing position relative to a door frame 210 (as shown in FIG. 2). In the meantime, the first sensing device 130 senses that the latch bolt 110 is located at the locking position and sends the locking position signal to the processing unit 150, and the second sensing device 140 senses that the door is located at the closing position and sends the closing position signal to processing unit 150. When the user unlocks the electric lock 100, such as inputting a password or a fingerprint to unlock the electric lock 100 (the user can also unlock the electric lock 100 manually), the processing unit 150 is configured to send the unlocking control signal to the actuator 120 to control the actuator 120 to drive the latch bolt 110 to move to the unlocking position (as shown in FIG. 3). In the meantime, the first sensing device 130 senses that the latch bolt 110 is located at the unlocking position and sends the unlocking position signal to the processing unit 150, and the second sensing device 140 senses that the door is located at the closing position and sends the closing position signal to the processing unit 150. When the user opens the door, the latch bolt 110 of the electric lock 100 is located at the unlocking position and the door 200 is moved away from the closing position relative to the door frame 210 (as shown in FIG. 4). In the meantime, the first sensing device 130 senses that the latch bolt 110 is located at the unlocking position and sends the unlocking position signal to the processing unit 150, and the second sensing device 140 senses that the door is away from the closing position and stops sending the closing position signal to the processing unit 150.

In a delayed locking mechanism of the electric lock of the present invention, when the user closes the door (switching from the state in FIG. 4 to the state in FIG. 3), the processing unit 150 is configured to control the actuator to immediately drive the latch bolt 110 to the locking position (within a very short period of time, such as within 1 second) while the second sensing device 140 further senses that the door 200 is moved to the closing position. According to the aforementioned arrangement, when the user closes the door, the delayed locking mechanism of the electric lock of the present invention immediately performs locking operation to prevent the door from being opened again.

In addition, the electric lock 100 of the present invention can further comprise a warning device 160. In the state shown in FIG. 4 (while the first sensing device 130 senses that the latch bolt 110 is located at the unlocking position and the second sensing device 140 senses that the door is away from the closing position), the processing unit 150 is further configured to control the warning device 160 to generate a warning notification when the first sensing device 130 further senses that the latch bolt 110 is moved to the locking position (or is moved away from the unlocking position). The warning notification includes, but not limited to, a sound warning, a light warning, or a wirelessly-transmitted message warning. According to the aforementioned arrangement, if the latch bolt 110 is moved to the locking position (or is moved away from the unlocking position) before the door returns to the closing position, the delayed locking mechanism of the electric lock of the present invention is configured to generate a warning notification to notify the user that the latch bolt 110 is moved to an incorrect position, so as to prevent the latch bolt 110 from hitting the door frame when the door returns to the closing position, which may cause damage to the latch bolt 110 or the door frame. In addition, the warning notification can also notify the user that the door is not closed properly, so as to avoid intrusion.

Furthermore, In the state shown in FIG. 4 (while the first sensing device 130 senses that the latch bolt 110 is located at the unlocking position and the second sensing device 140 senses that the door is not located at the closing position), the processing unit 150 is further configured to control the warning device 160 to generate a warning notification after the second sensing device 140 senses that the door 200 is away from the closing position for a duration exceeding a first predetermined delay time. The warning notification includes, but not limited to, a sound warning, a light warning, or a wirelessly-transmitted message warning. According to the aforementioned arrangement, when the door 200 is opened for more than the first predetermined delay time, the delayed locking mechanism of the electric lock of the present invention is configured to generate a warning notification to notify the user that the door 200 has been opened for more than the first predetermined delay time and is still open. Therefore, the user can further close the door to avoid intrusion.

On the other hand, when the user unlocks the electric lock 100 and does not open the door (as the state shown in FIG. 3, while the first sensing device 130 senses that the latch bolt 110 is located at the unlocking position and the second sensing device 140 senses that the door is located at the closing position), the processing unit 150 is further configured to control the actuator 120 to drive the latch bolt 110 to move to the locking position after the second sensing device 140 senses that the door 200 has been continuously located at the closing position for a duration exceeding a second predetermined delay time. According to the aforementioned arrangement, when the electric lock 100 is unlocked and the door 200 is not opened for more than the second predetermined delay time, the delayed locking mechanism of the electric lock of the present invention is configured to automatically move the latch bolt 110 to the locking position to avoid intrusion.

In the embodiments of the present invention, lengths of the first predetermined delay time and the second predetermined delay time can be identical or different. The lengths of the first predetermined delay time and the second predetermined delay time can be determined according to usage requirements or design requirements.

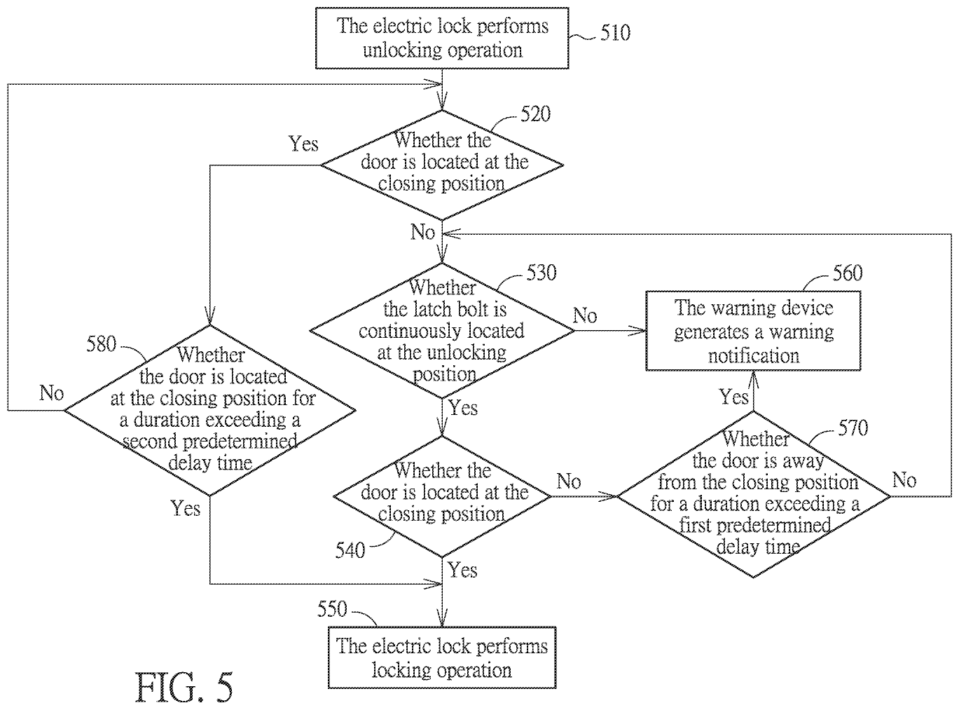

Please refer to FIG. 5, and refer to FIG. 1 to FIG. 4 as well. FIG. 5 is a flow chart of a control method of the electric lock of the present invention. The flow chart of the control method of the electric lock of the present invention comprises the following steps:
Step 510: The electric lock 100 performs unlocking operation to move the latch bolt 110 to the unlocking position;
Step 520: The second sensing device 140 senses whether the door 200 is located at the closing position; if so, go to step 580; if not, go to step 530;
Step 530: The first sensing device 130 senses whether the latch bolt 110 is continuously located at the unlocking position; if so, go to step 540; if not, go to step 560;
Step 540: The second sensing device 140 senses whether the door 200 is located at the closing position; if so, go to step 550; if not, go to step 570;
Step 550: The electric lock 100 performs locking operation to move the latch bolt 110 to the locking position;
Step 560: The processing unit 150 controls the warning device 160 to generate a warning notification;
Step 570: The second sensing device 140 senses whether the door 200 is away from the closing position for a duration exceeding a first predetermined delay time; if so, go to step 560; if not, go to step 530; and
Step 580: The second sensing device 140 senses whether the door 200 is located at the closing position for a duration exceeding a second predetermined delay time; if so, go to step 550; if not, go to step 520.

In addition, in the control method of the electric lock of the present invention, the aforementioned steps need not be in the exact order shown. That is, the order of the steps can be changed and other steps can be inserted in between, or more steps can also be added. For example, after the warning notification is generated in step 560, a step of dismissing the warning and a step of resetting the electric lock to a certain state can be further performed (for example, the processing unit 150 controls the actuator 120 to reset the latch bolt 110 to the unlocking position), and then step 530 is performed again.

In contrast to the prior art, the electric lock of the present invention has two sensing devices to sense the positions of the latch bolt and the door respectively, such that the delayed locking mechanism of the electric lock of the present invention can perform the locking operation immediately when the door returns to the closing position, so as to prevent the door from being opened again. Therefore, the delay locking mechanism of the electric lock of the present invention has better security. Furthermore, the delayed locking mechanism of the electric lock of the present invention can generate a warning notification when the latch bolt is located at an incorrect position or the door has been opened for a duration exceeding a predetermined delay time, so as to further increase the security.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electric lock, comprising:
a latch bolt movable relative to a door between a locking position and an unlocking position;
an actuator configured to drive the latch bolt to move;
a first sensing device configured to sense a position of the latch bolt;
a second sensing device configured to sense whether the door is located at a closing position; and
a processing unit configured to control the actuator to drive the latch bolt to move;
wherein in a state of the first sensing device sensing that the latch bolt is located at the unlocking position and the second sensing device sensing that the door is not located at the closing position, the processing unit is configured to control the actuator to drive the latch bolt to move to the locking position when the second sensing device further senses that the door is moved to the closing position.

2. The electric lock of claim 1, further comprising a warning device, wherein in the state of the first sensing device sensing that the latch bolt is located at the unlocking position and the second sensing device sensing that the door is not located at the closing position, the processing unit is further configured to control the warning device to generate a warning notification when the first sensing device further senses that the latch bolt is moved to the locking position.

3. The electric lock of claim 1, further comprising a warning device, wherein in the state of the first sensing device sensing that the latch bolt is located at the unlocking position and the second sensing device sensing that the door is not located at the closing position, the processing unit is further configured to control the warning device to generate a warning notification when the first sensing device further senses that the latch bolt is moved away from the unlocking position.

4. The electric lock of claim 1, further comprising a warning device, wherein in the state of the first sensing device sensing that the latch bolt is located at the unlocking position and the second sensing device sensing that the door is not located at the closing position, the processing unit is further configured to control the warning device to generate a warning notification when the second sensing device senses that the door is away from the closing position for a duration exceeding a predetermined delay time.

5. The electric lock of claim 1, wherein in a state of the first sensing device sensing that the latch bolt is located at the unlocking position and the second sensing device sensing that the door is located at the closing position, the processing unit is further configured to control the actuator to drive the latch bolt to move to the locking position when the second sensing device senses that the door is located at the closing position for a duration exceeding a predetermined delay time.

6. The electric lock of claim 1, wherein in the state of the first sensing device sensing that the latch bolt is located at the unlocking position and the second sensing device sensing that the door is not located at the closing position, the processing unit is further configured to control the actuator to drive the latch bolt to move to the locking position when the first sensing device continuously senses that the latch bolt is located at the unlocking position and when the second sensing device further senses that the door is moved to the closing position.

7. The electric lock of claim 1, wherein when the second sensing device senses that the door is not located at the closing position, the first sensing device is configured to sense whether the latch bolt is located at the unlocking position.

8. An electric lock control method, comprising:
arranging an electric lock on a door, wherein the electric lock comprises a latch bolt, an actuator, a first sensing device, a second sensing device and a processing unit, wherein the latch bolt is movable relative to the door between a locking position and an unlocking position;
the first sensing device sensing a position of the latch bolt;
the second sensing device sensing whether the door is located at a closing position; and
in a state of the first sensing device sensing that the latch bolt is located at the unlocking position and the second sensing device sensing that the door is not located at the closing position, the processing unit controlling the actuator to drive the latch bolt to move to the locking position when the second sensing device further senses that the door is moved to the closing position.

9. The control method of claim 8, wherein the electric lock further comprises a warning device, the control method further comprises in the state of the first sensing device sensing that the latch bolt is located at the unlocking position and the second sensing device sensing that the door is not located at the closing position, the processing unit controlling the warning device to generate a warning notification when the first sensing device further senses that the latch bolt is moved to the locking position.

10. The control method of claim 8, wherein the electric lock further comprises a warning device, the control method further comprises in the state of the first sensing device sensing that the latch bolt is located at the unlocking position and the second sensing device sensing that the door is not located at the closing position, the processing unit controlling the warning device to generate a warning notification when the first sensing device further senses that the latch bolt is moved away from the unlocking position.

11. The control method of claim 8, wherein the electric lock further comprises a warning device, the control method further comprises in the state of the first sensing device sensing that the latch bolt is located at the unlocking position and the second sensing device sensing that the door is not located at the closing position, the processing unit controlling the warning device to generate a warning notification when the second sensing device senses that the door is away from the closing position for a duration exceeding a predetermined delay time.

12. The control method of claim 8, further comprising in a state of the first sensing device sensing that the latch bolt is located at the unlocking position and the second sensing device sensing that the door is located at the closing position, the processing unit controlling the actuator to drive the latch bolt to move to the locking position when the second sensing device senses that the door is located at the closing position for a duration exceeding a predetermined delay time.

13. The control method of claim 8, wherein in the state of the first sensing device sensing that the latch bolt is located at the unlocking position and the second sensing device sensing that the door is not located at the closing position, the processing unit controlling the actuator to drive the latch bolt to move to the locking position when the first sensing device continuously senses that the latch bolt is located at the unlocking position and when the second sensing device further senses that the door is moved to the closing position.

14. The control method of claim 8, further comprising the first sensing device sensing whether the latch bolt is located at the unlocking position when the second sensing device senses that the door is not located at the closing position.
